(19) United States
(12) Patent Application Publication
(10) Pub. No.: US 2024/0009970 A1
(43) Pub. Date: Jan. 11, 2024

(54) LAMINATED LIQUID CRYSTAL GLAZING AND METHOD FOR PRODUCING SAME

(71) Applicant: SAINT-GOBAIN GLASS FRANCE, COURBEVOIE (FR)

(72) Inventors: Laurent MAILLAUD, MASSY (FR); Michael LABROT, AACHEN (DE); Adil JAAFAR, MARGNY-LES-COMPIEGNE (FR)

(73) Assignee: SAINT-GOBAIN GLASS FRANCE, COURBEVOIE (FR)

(21) Appl. No.: 18/026,942

(22) PCT Filed: Sep. 15, 2021
(86) PCT No.: PCT/FR2021/051584

§ 371 Date: Mar. 17, 2023

(30) Foreign Application Priority Data
Sep. 18, 2020 (FR) FR2009467

(51) Int. Cl. B32B 17/10

(52) U.S. Cl. CPC B32B 17/10504; B32B 17/10036; B32B 17/10908; B32B 17/10761; B32B 17/10651; B32B 17/10137; B32B 17/10174

(57) ABSTRACT

A laminated glazing (1) with liquid crystal variable transmission, comprising a first glass substrate (10) and a second glass substrate (11), at least one liquid crystal cell (2), a first interlayer (30) placed between the first glass substrate (10) and the liquid crystal cell (2), and a second interlayer (40) placed between the second glass substrate (11) and the liquid crystal cell (2), characterized in that said first interlayer (30) is a film made of a polymeric material and in that said second interlayer (40) is made of a transparent adhesive material (OCA) that is in the form of a liquid, prior to the manufacture of the glazing, and is crosslinkable.

The invention relates to the field of electrically controllable glazings having variable optical properties, and more particularly relates to a laminated glazing having liquid crystal variable transmission.

The invention will be applicable to all uses, particularly for construction, such as exterior walls or partitions or other interior glazed surfaces, or for vehicles such as cars, buses, trains and aircraft.

A laminated glazing having liquid crystal variable transmission comprises at least two main glass substrates, two interlayers made of plastic material for laminating the glass substrates, most commonly made of polyvinyl butyral (PVB), and a liquid crystal cell placed between the two lamination interlayers. The liquid crystal cell comprises liquid crystals encapsulated between two polymeric encapsulation films which are kept at a constant distance by virtue of spacers such as glass beads. Each polymeric encapsulation film is provided with an electrode. When a voltage is applied to the electrodes, the liquid crystals associated with dyes change orientation and modify the light transmission through the cell, with the glazing passing from a light state to a dark state, or vice-versa. “Light state” and “dark state” are intended to mean that the glazing has, in the light state thereof, a light transmission in the visible range which is greater than the light transmission it has in the dark state thereof. The liquid crystal cell can comprise, in combination with the liquid crystals, dichroic dyes and/or polarizers on the outside of the faces thereof. Depending on the targeted application, on the equilibrium orientation of the liquid crystals interacting with the dichroic dyes when they are present, the light and dark states will correspond to an ON/OFF state or an OFF/ON state of powering of the electrodes. Reference will be made to a “normally light” state of the glazing when the light transmission is highest in the absence of voltage between the electrodes (OFF state), thereby permitting viewing through the glazing, while the dark state of said glazing will correspond to the electrodes being powered (ON state), causing re-orientation of the liquid crystals and a modification of the light transmission (with the light transmission becoming lower). Conversely, reference will be made to a “normally dark” state of the glazing when the light transmission is lower in the absence of voltage while, when a voltage is applied, the glazing will become light.

The polymeric nature of the cell encapsulation films, most commonly made of polyethylene terephthalate (PET) or polycarbonate (PC), makes it possible to readily laminate the cell to the PVB lamination interlayers of the glass substrates.

However, the process for manufacturing a laminated glazing, due to high pressures and temperatures used during the lamination steps by implementing a vacuum bag and an autoclave, can lead to local deformations of the polymeric encapsulation films for the liquid crystal cell, in particular a thickening of the cell, causing local modification of the orientation of the liquid crystals. This results in an inhomogeneity in the light transmission for the glazing, which is further visibly reflected in the presence of dark zones in a normally light glazing or conversely in the presence of light zones in a normally dark glazing. It is sought to prevent this inhomogeneity in light transmission.

Moreover, the cyclical deformation of the cell due to temperature variation cycles in the use of the glazing, also adversely affects the transparent electrodes, in particular with a risk of crack propagation, which leads to a drop in, or even a loss of, the electrical conductivity, and to the malfunctioning of the cell.

The aim of the invention is therefore to overcome the abovementioned disadvantages by proposing a novel laminated glazing composition and a novel manufacturing process, so as to minimize the risk of deformation of the cell and to prevent the presence of zones which are inhomogeneous in terms of light transmission compared to the rest of the glazing, and also to prevent damage to the electrodes.

According to the invention, the laminated glazing with liquid crystal variable transmission comprises a first glass substrate and a second glass substrate, at least one liquid crystal cell, a first interlayer placed between the first glass substrate and the liquid crystal cell, and a second interlayer placed between the second glass substrate and the liquid crystal cell, the laminated glazing being characterized in that said first interlayer is a film made of a polymeric material and in that said second interlayer is made of a transparent adhesive material (also referred to as OCA for optically clear adhesive) that is in the form of a liquid prior to the manufacture of the glazing, and is crosslinkable.

The expression “prior to the process for manufacturing the laminated glazing” is intended to mean before the assembly of all the elements constituting the glazing.

In the following description, “film” is intended to mean a monolithic element in the form of a sheet which can be handled.

The first interlayer is in the form of a polymeric film in order to be able to be laminated to a glass substrate. This polymeric film is secured to the first glass substrate during the process for laminating the glazing.

Before being added to the laminated glazing, the second interlayer is in the form of a liquid OCA in order to be deposited in liquid form between the liquid crystal cell and the second glass substrate, this liquid OCA being able to be crosslinked in order, once it has cured, to form said second interlayer. The OCA is crosslinked after it has been deposited, for example by polymerization means such as ultraviolet radiation. Unlike the first interlayer, the second interlayer is therefore not in the form of a film before it is secured to the second glass substrate.

The liquid crystal cell is present in the manner of a film extending over all or part of the surface of the glazing. The liquid crystal cell has two opposing faces, facing, respectively, the first and second interlayers.

Thus, the liquid crystal cell only undergoes the lamination process on a single one of its faces, in order to ensure it is secured to the first glass substrate via the first interlayer, while its other face is secured to the second glass substrate by a liquid OCA which is able to crosslink/cure, involving a process with much less demanding implementation for the cell. The mechanical stresses of the lamination operation (high temperature and high pressure) are only exerted on a single face of the cell and not on both of its faces, such that the risk of modifying the thickness of the cell is reduced, minimizing the risk of the presence of zones which are inhomogeneous in terms of light transmission on the glazing at the end of manufacture. Moreover, the use of a crosslinkable transparent liquid adhesive (OCA) affords it dimensional stability and reduces its deformation upon compression when the second glass substrate is added.

Advantageously, the liquid crystals may be in the form of a liquid volume of liquid crystals. The liquid volume is trapped in the cavity delimited by the cell encapsulation substrates and a peripheral seal.

When the liquid crystal cell is free of dyes, it comprises two polarizers. The polarizers are then associated with the outer faces of the glass cell encapsulation substrates (faces opposite the cavity containing the liquid volume).

The liquid volume of liquid crystals may comprise one or more dichroic dyes. The liquid crystal cell comprising a liquid mixture of liquid cells wherein one or more dichroic dyes are dispersed is referred to in the following description as a “guest-host” liquid crystal cell.

The liquid crystal cell comprising a guest-host liquid mixture may further comprise one or more polarizers (on one or the outer face(s) of the cell).

According to one feature, said first interlayer is based on at least one polymer selected from the following polymers: polyvinyl butyral (PVB), ethylene-vinyl acetate (EVA), polyurethane (PU), polyethylene terephthalate (PET), polyethylene, polycarbonate, polymethyl methacrylate, polyacrylate, polyvinyl chloride, polyacetate resin, acrylate, fluorinated ethylene propylene, polyvinyl fluoride, ethylene tetrafluoroethylene, cyclic olefin copolymer (COC). Preferably, said first interlayer is a film made of polyvinyl butyral (PVB) or of ethylene-vinyl acetate (EVA), or of polyurethane (PU), or of polyethylene terephthalate (PET).

By using, as first interlayer, a sheet or film made of polymeric material, such as PVB, the glazing retains its mechanical strength properties in order in particular to comply with certain standards, for example in terms of road safety. In addition, this type of film, commonly commercially available, is often manufactured to have one or more other functionalities such as acoustic, anti-reflective, non-stick, scratch-proof, photocatalytic, anti-fingerprint, anti-fog, coloring, etc., properties, thus affording at the same time additional properties to the glazing depending on the intended use.

The glazing may advantageously comprise one or more ultraviolet filters. In a preferred example, said first interlayer constitutes an ultraviolet filter; the first interlayer is for example ultraviolet-filtering PVB. Aside from the known advantages of UV block for a glazing, such a filter prolongs the life of the liquid crystal glazing, in particular when the liquid crystal cell is a guest-host cell, because it prevents the degradation of the dichroic dyes. When at least one ultraviolet-filtering film is placed between the liquid crystal cell and the first glass substrate, said first glass substrate will be intended to be facing the exterior environment if the glazing is intended to be installed in an opening separating an interior from the exterior environment.

If there were really a need for an ultraviolet filter for the liquid crystal cell on the side of the face associated with the OCA, then the OCA will be selected to filter ultraviolet rays, the liquid OCA containing for example additives which absorb ultraviolet rays, and will be crosslinkable other than by ultraviolet radiation.

According to another feature, the laminated glazing comprises a superposition of one or more other interlayer films made of polymeric material (in addition to the first interlayer), placed between the first glass substrate and the liquid crystal cell, each of the interlayers constituting a film which may be provided with technical functionalities (ultraviolet-filtering properties or other properties). These other interlayers are secured to the first glass substrate and to the liquid crystal cell by the lamination process.

Advantageously, the laminated glazing comprises a frame made of polymeric material which is arranged all around the liquid crystal cell and in contact with said first interlayer, said frame preferably constituting an ultraviolet filter. The frame is arranged between the two interlayers of the glazing, without protruding relative to the rim of the glazing. Indeed, it may be that the surface of the liquid crystal cell is only associated with a portion of the surface of the glazing. The space existing between the two interlayer films and all around the cell is therefore compensated for by arranging a frame there (which therefore covers the whole of the peripheral edge face of the cell), this frame being made of a polymeric material in order to provide lamination. The frame may be made of one of the materials mentioned above for forming the interlayer film.

It is advantageously proposed to provide the polymeric frame with an additional ultraviolet-filtering function. This additional configuration of ultraviolet filtering over the whole periphery of the rim of the liquid crystal cell maximizes the protection of the cell from ultraviolet rays, since the liquid crystal cell is not only protected on its main faces but also on its edge face.

This configuration of ultraviolet-filtering frame is particularly useful when the liquid crystal cell is a guest-host liquid crystal cell, that is one containing dyes, so as to protect the dyes from ultraviolet rays. Indeed, the inventors have demonstrated that the degradation of the dichroic dyes could occur via the edge face of the guest-host cell. Although the edge face of the liquid crystal cell represents a small surface area compared to the main faces of the cell, surprisingly, in reality, the impact of ultraviolet rays through the edge face of the cell is not inconsiderable. The guest-host liquid crystal cell may be affected during transport of the laminated glazings in its different storage locations before being definitively installed, and even after installation of the laminated glazing, depending on the type of use.

Consequently, the frame surrounding the liquid crystal cell, due to its additional ultraviolet filter function, will provide increased protection to the cell as soon as it is integrated into the glazing and until said glazing is finally installed, as well as during the use of the glazing.

The ultraviolet filter(s) (which may be the first lamination interlayer and/or the polymeric frame and/or the other superposed interlayer film(s)) are designed such that each filter has a light transmission at least between 280 nm and 400 nm, in particular has a light transmission at 400 nm, which is less than 1%, preferably less than 0.1%, more preferably still less than 0.01%. The light transmission is measured according to standard ISO 13887.

If an ultraviolet filter is effective below 400 nm, the ultraviolet absorption is not always so at 400 nm, at the limit of the visible spectrum. Here, the filter(s) are designed to absorb ultraviolet rays at 400 nm. A filter which absorbs ultraviolet rays at 400 nm will necessarily work for rays of less than 400 nm.

Moreover, the ultraviolet filter selected will preferably be designed such that the particles for absorbing ultraviolet rays do not excessively disrupt the color of the filter; in particular, the filter will be adapted such that its color does not tend toward yellow.

To achieve light transmission of less than 0.01% for an ultraviolet filter in the form of at least one interlayer film, the laminated glazing may comprise a single interlayer film having this property of light transmission of less than 0.01%, or may comprise the combination of a plurality of superposed interlayer films, the combination making it possible to obtain light transmission of less than 0.01%.

For example, by superposing two commercially available ultraviolet-filtering PVB films, each of which has light transmission at 400 nm of less than 1%, the first film constituting the first interlayer and the second film constituting an additional interlayer, the superposition of the two interlayer films provides a filter for which the light transmission at 400 nm reaches less than 0.01%. The ultraviolet filter therefore has high performance at 400 nm, and even more so for the range below 400 nm for which light transmission tends toward zero.

According to another feature, said second interlayer made from a transparent adhesive material (OCA) is selected from the following materials: acrylic, polyvinyl acetate (PVA), polyurethane (PU), silicone and epoxy. The second interlayer has, in the laminated glazing (after manufacture) a thickness of less than 1 mm, or even of less than 0.5 mm.

According to a preferential feature, the liquid crystal cell is a liquid crystal cell comprising a liquid volume of liquid crystals. It became apparent that, during the process of laminating the cell in the autoclave, the cell is subjected to fewer stresses than if the matrix containing the liquid crystals were a solid polymer such as the cells of the prior art. In addition, this contributes to minimizing the risk of variation in the thickness of the cell during the lamination process when the cell passes into the autoclave, and makes it possible to greatly minimize visual defects once the glazing is finished and then during the use thereof, even more so when the glazing is curved.

According to yet another feature, the laminated glazing may comprise two liquid crystal cells, optionally of different types. When the laminated glazing comprises two liquid crystal cells, at least one of them is a cell comprising a liquid volume of liquid crystals mixed with dichroic dyes, the other liquid crystal cell being a liquid crystal system wherein the volume of liquid crystals is not in liquid form, such as a polymer-dispersed liquid crystal system, “PDLC” (where the liquid crystals are dispersed in a polymer matrix), or a cholesteric liquid crystal system, “CLC”, or else a polymer network liquid crystal system, “PNLC”.

When the laminated glazing comprises two liquid crystal cells, the two liquid crystal cells are coupled to one another by an adhesive material. If the two cells are coupled to one another before the lamination, it is the combination of both which will be laminated with the first glass substrate via the first polymeric interlayer. If the second cell is coupled to the first cell after the lamination, the second cell will be attached by bonding to the first cell, for example by an OCA which may be of the same nature as the adhesive-bonding OCA which serves to secure the second glass substrate. The combination of two cells will in particular make it possible to provide more intense darkness.

When the laminated glazing additionally comprises a liquid crystal system other than a liquid crystal cell, the liquid crystal volume of which is in liquid form, in particular a PDLC film, said system will be secured by the lamination process or will be attached by adhesive bonding. Thus, said other liquid crystal system will be arranged and secured by lamination between the liquid crystal cell and the first interlayer, or else will be secured to the liquid crystal cell by an adhesive layer on the side opposite the first interlayer.

When said other liquid crystal system is laminated between the first interlayer and an additional interlayer, the first interlayer and the additional interlayer will be ultraviolet filters, which will even better protect the guest-host liquid crystal cell comprising dyes.

Said other liquid crystal system, in particular the PDLC film, can advantageously provide a function of varying the light scattering to the glazing. In particular when the glazing is dark, the dark aspect will be more intense, associated with a larger variation in light transmission.

Said other liquid crystal system, in particular the PDLC film, will be able to be powered concomitantly or not to the powering of the liquid crystal cell. The control of said other liquid crystal system will be able to be independent of that of the liquid crystal cell.

Moreover, the laminated glazing may comprise at least one functional infrared protection layer, the functional layer being arranged inside the laminated glazing, for example applied to the inner face of the first glass substrate and/or of the second glass substrate, and/or of the first interlayer, or consists of the first interlayer, and/or consists of another interlayer secured to the first interlayer. This infrared protection layer will be particularly useful for reflecting infrared rays in order not to heat the liquid crystal cell. Indeed, too high a temperature will adversely affect the proper functioning of the liquid crystals, with the risk of phase transition. Furthermore, the risk of crack propagation (linked to cycles of deformation due to the cycles of temperature variation in the position of use of the glazing) at the electrodes of the liquid crystal cell is also minimized.

In a particular application example, the laminated glazing comprises an infrared protection layer on the inner face of the first glass substrate (face 2 of the glazing in the installed position of the glazing in contact with the exterior environment—face 1 of the glazing is the face in contact with the exterior environment, by convention) to protect the cell from infrared radiation originating from the exterior, an ultraviolet filter formed by the first lamination interlayer with the first glass substrate, the interlayer preferably being a PVB film and being able to be tinted, and a low-emissivity layer on the outer face of the second glass substrate (face 4 of the glazing), the aim of which is to reflect long-wavelength infrared rays originating from inside a passenger compartment or an interior room.

The laminated glazing may comprise other functionalities, which are added via coatings in direct contact with the glass substrates and/or the first interlayer and/an additional interlayer associated with the first interlayer or with one of the first and second glass substrates, and/or formed by the first interlayer and/or formed by an additional interlayer associated with the first interlayer or with one of the first and second glass substrates. These various functionalities are for example acoustic, anti-reflective, non-stick, scratch-proof, photocatalytic, anti-fingerprint, anti-fog, coloring, etc., properties.

When an additional interlayer is added to the laminated glazing, this interlayer can be secured during the lamination when it will be between the first glass substrate and the liquid crystal cell; when the additional interlayer will be arranged between the liquid crystal cell and the second glass substrate, it will be attached by adhesive bonding or will have been pre-laminated with the second glass substrate.

Regarding the liquid crystal cell, it comprises substrates for the encapsulation of the liquid crystal volume, said encapsulation substrates being polymeric or glass-based. While the encapsulation substrates are customarily made of polymeric material, the inventors propose a novel form of encapsulation by substrates made of ultrathin glass, in particular when the liquid crystal volume of the liquid crystal cell is in liquid form, optionally comprising one or more dichroic dyes.

In the case of glass encapsulation substrates, they are ultrathin, making the cell flexible like a film in order to easily handle it and in particular laminate it with the main glass substrates of the glazing when the latter are curved. The inventors have demonstrated, unexpectedly, that the liquid crystal cell manufactured from glass encapsulation substrates rather than encapsulation films made of plastic material is much less subject to local variation in thickness during the lamination process, even more so when the liquid crystal volume is liquid. The glazing remains homogeneous in hue, with no colored marks appearing.

Moreover, the inventors have demonstrated, unexpectedly, that the use of a liquid crystal cell made from glass encapsulation substrates (in particular when the encapsulated liquid crystal volume is liquid) is particularly effective in the manufacture of a curved laminated glazing; no zone which is inhomogeneous in terms of light transmission is detected in the curved laminated glazing.

Even more particularly, the inventors have demonstrated, unexpectedly, that the use of chemically tempered glass encapsulation substrates even better prevents the risk of thickness variations in the cell during the lamination process. Thus, preferably, each of the glass encapsulation substrates of the liquid crystal cell is made of chemically tempered glass.

According to one feature, each of the glass encapsulation substrates of the liquid crystal cell has a thickness such that the liquid crystal cell constitutes a flexible film, that is at ambient temperature it follows the shape of the surface on which said flexible film/said cell is deposited.

In particular, each of the glass encapsulation substrates of the liquid crystal cell has a minimal radius of curvature which is approximately 600 mm and may even reach 200 mm.

Each of the glass encapsulation substrates of the liquid crystal cell has a thickness of less than 1000 μm, in particular of between 25 μm and 700 μm, preferably a thickness of less than 300 μm, or even of less than 100 μm.

The laminated glazing of the invention may constitute a building or vehicle glazing, particularly for a vehicle selected from a car, a train, a truck, an aircraft, a bus, a military vehicle.

If it is a vehicle glazing, the laminated glazing is in particular selected from a roof glazing, a rear window, a side window, a windscreen and a shaded strip at the upper part of the windscreen.

The laminated glazing may be planar or curved.

The laminated glazing may be used in a double glazing or in a triple glazing.

The invention also relates to a process for manufacturing the above-mentioned laminated glazing of the invention, the steps of which process are as follows:
positioning, on a support surface such as a counter-glass, which is coated with a non-stick coating, for example made of PTFE, the liquid crystal cell, the liquid crystal cell preferably consisting of a liquid mixture (volume) of liquid crystals and optionally of at least one dichroic dye and, if required, arranging a frame surrounding the liquid crystal cell, then positioning the first interlayer in the form of a polymeric material film, optionally other elements to be laminated (such as a PDLC system and an additional interlayer film), and finally the first glass substrate, so as to form a stack;
carrying out the stack lamination operation in order to form a laminated assembly; the operation is well known per se, preferably with placing the stack assembly in a vacuum bag (instead of implementing a calendering operation on the stack in order to evacuate the air) and passing into an autoclave;
removing the support surface (the counter-glass) from the laminated assembly which is composed of the first glass substrate, the first interlayer, the liquid crystal cell and optionally the frame;
arranging the liquid OCA between the second glass substrate and the laminated assembly on the side of the liquid crystal cell;
crosslinking the liquid OCA to obtain the laminated glazing.

Consequently, the process only performs the lamination operation on a single face of the cell, minimizing the risk of variation in the thickness thereof. Once the counter-glass has been removed, the liquid crystal cell relaxes and any inhomogeneous light transmission marks disappear. Furthermore, the deposition, on the other face of the cell, of a liquid material will prevent thickness deformation on the side of this face and will afford surface planarity to the interface between this other face of the cell and the second glass substrate. The laminated glazing (in the sense of a stack of material) will have lower risks of inhomogeneous light transmission.

The frame made of polymeric material can be attached around the liquid crystal cell once the latter has been deposited on the first interlayer. As a variant, the frame may already be secured to the contour of the liquid crystal cell, the cell and the frame forming a one-piece assembly which is deposited on the first interlayer.

The present invention is now described by means of examples that are solely illustrative and in no way limiting with respect to the scope of the invention, and on the basis of the attached illustrations, in which:

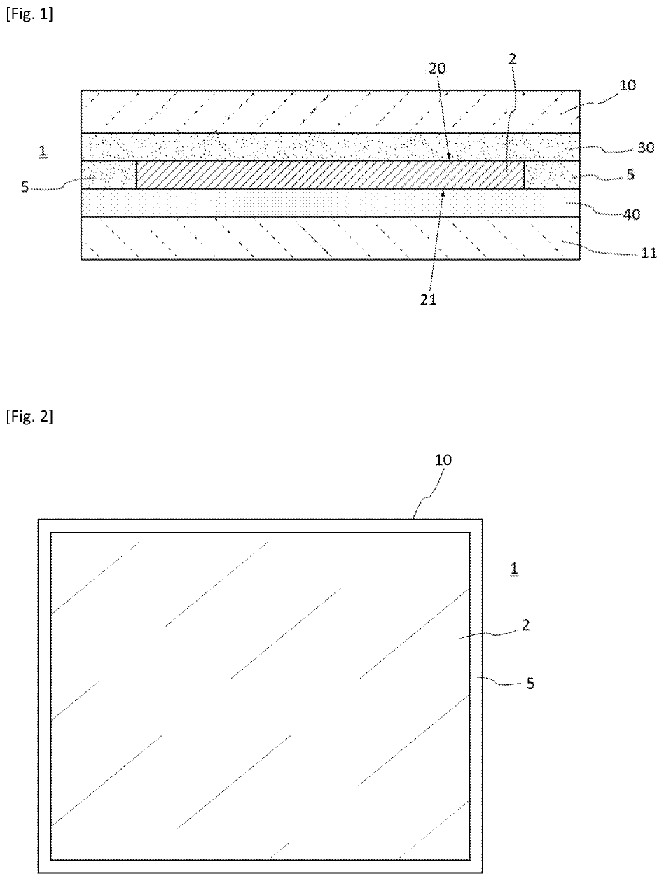

FIG. 1 depicts a schematic lateral sectional view of a first exemplary embodiment of a laminated glazing according to the invention.

FIG. 2 depicts a schematic plan view of the laminated glazing of FIG. 1.

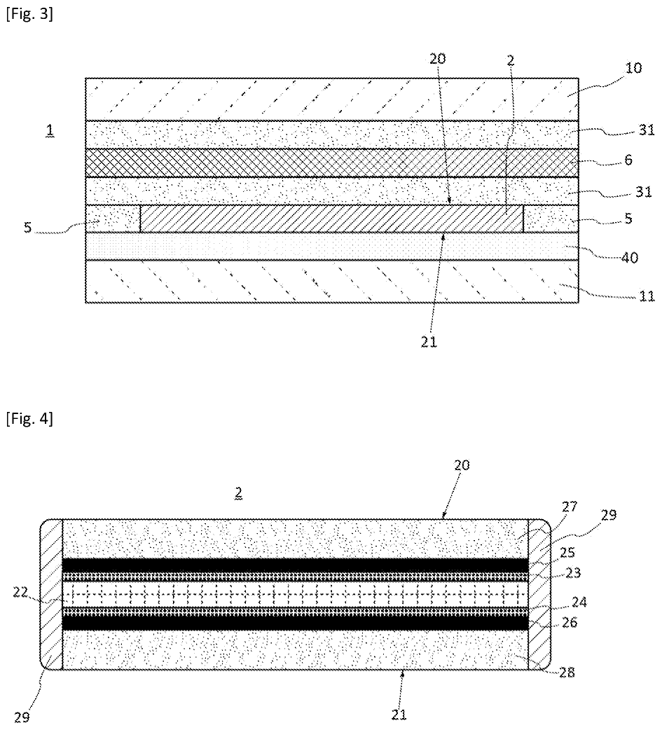

FIG. 3 depicts a schematic lateral sectional view of a second exemplary embodiment of a laminated glazing according to the invention.

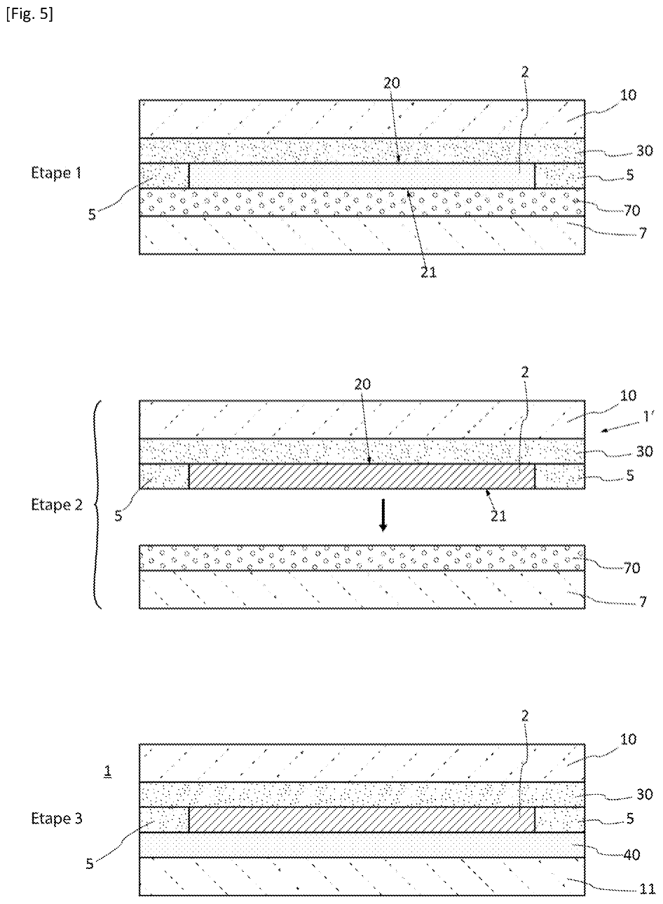

FIG. 4 is a schematic detail view of the guest-host cell of the exemplary embodiments of FIGS. 1 and 3.

FIG. 5 is a schematic view of the steps of the manufacturing process according to the invention for obtaining the laminated glazing of FIG. 1.

For the sake of clarity, the various elements depicted in the figures are not necessarily reproduced to scale.

The laminated glazing 1 of the invention illustrated in FIG. 1 is a liquid crystal variable transmission laminated glazing comprising a liquid crystal cell 2.

The laminated glazing 1 is intended for an application in construction or an application in vehicles. The light transmission of the laminated glazing 1 is modified when an electric voltage is applied to the electrodes of the liquid crystal cell 2. The glazing 1 may be normally light (high light transmission, such as approximately 70%) in the absence of voltage, and become dark (low light transmission, such as approximately 25%) by applying a voltage. Conversely, the glazing can be designed to be normally dark when not powered; it then becomes light by applying a voltage. The normally light or normally dark state is based on the use of the glazing. In the light state thereof, the glazing may have a colored or colorless appearance depending on the targeted application (glass substrate(s) and/or interlayer film(s), or even the liquid crystal cell, possibly being tinted).

The laminated glazing 1 of the first example illustrated in FIG. 1 comprises:
a first glass substrate 10;
a second glass substrate 11 arranged at a distance from, and opposite, the first substrate 10;
the liquid crystal cell 2, arranged at the core of the glazing and having two main opposing faces 20 and 21;
a first lamination interlayer 30 between the first substrate 10 and one of the main faces 20 of the cell 2;
a second interlayer 40 which makes it possible to secure the second substrate 11 and the opposite main face 21 of the cell 2, by a process other than the lamination process.

The liquid crystal cell 2 is surrounded by a frame 5. The frame 5 is for example made of PVB or epoxy resin. As can be seen in FIG. 2, when the liquid crystal cell 2 does not extend over the whole surface of the glazing, the frame 5 serves as a spacer of the same thickness as that of the liquid crystal cell 2, in order to fill the empty space which would otherwise exist between the two interlayers 30 and 40.

Depending on the uses made of the laminated glazing 1 described below with regard to the figures or in envisioned variants (not shown), the laminated glazing will be employed as is in a one-piece manner, or will be combined with one or other glass substrates in a laminate with the first substrate, or with one or other glass substrates spaced apart from the first substrate and/or from the second substrate.

In the second exemplary embodiment illustrated in FIG. 3, the laminated glazing 1 comprises, between the liquid crystal cell 2 and the first glass substrate 10, another liquid crystal system 6, such as a PDLC, laminated between the first interlayer 30 and an additional interlayer 31, the latter being laminated with the first substrate 10. On the opposite face 21 of the liquid crystal cell 2, like for FIG. 1, the second interlayer 40 makes it possible to secure the second glass substrate 11 of said opposite face 21 of the cell 2, without a lamination process.

The glass substrates 10 and 11 have a thickness which is suited to the use of the laminated glazing. The thickness may be between 0.3 mm and 15 mm, preferably between 1 to 5 mm; it is for example 1.6 mm, 1.8 mm or 2.1 mm.

The lamination interlayers 30 and 31 are films made of polymeric material such as PVB. In particular, they have a thickness of between 0.07 mm and 2 mm, in particular is 0.38 mm or 0.76 mm.

The lamination interlayers 30 and 31 and/or the glass substrates 10 and 11 may have technical functionalities, such as ultraviolet blocking, infrared protection, acoustic, anti-reflective, non-stick, scratch-proof, photocatalytic, anti-fingerprint, anti-fog, coloring properties.

The liquid crystal cell 2 is preferably a liquid crystal cell comprising a liquid volume of liquid crystals. In the present example, the liquid crystal cell is a guest-host liquid crystal cell comprising a liquid volume 22 of liquid crystals mixed with at least one dichroic dye. As shown in FIG. 4, the liquid crystal cell 2 comprises the liquid mixture 22, two alignment layers 23 and 24, two electrodes 25 and 26, two glass encapsulation substrates 27 and 28, and a seal 29. The two glass encapsulation substrates 27 and 28 are kept spaced apart by glass spacers (not shown) and form, with the seal 29, a cavity which accommodates the liquid crystal liquid volume 22. The leak-tightness of the edge face of the cell is produced by the peripheral seal 29, for example made of epoxy resin or silicone. The spacers are arranged throughout the cavity and preferentially also the seal. The inner surface facing the cavity of each of the two encapsulation substrates 27 and 28 is coated by the electrode 25, respectively 26, made of ITO, itself coated by the alignment layer 23, respectively 24, the alignment layers 23 and 24 being in contact with the liquid volume 22. The liquid crystal cell 2 has a total thickness of between 250 and 350 μm. The height of the cavity corresponds to the height of the spacers, the cavity having a height in particular of approximately 10 μm.

The two encapsulation substrates 27 and 28 of the liquid crystal cell 2 are made of thin glass. They are preferably made of chemically tempered glass. Each of the glass encapsulation substrates 27, 28 has a thickness of less than 1000 μm, in particular of between 25 μm and 700 μm, preferably a thickness of less than 300 μm, or even of less than 100 μm. The glass thickness of each encapsulation substrate is thin enough to afford the liquid crystal cell flexibility in the manner of a film when it is required to associate the cell to the glass substrates 10 and 11, all the more so when the latter are curved. In particular, the glass thickness of each glass encapsulation substrate 27, 28 is such that each glass encapsulation substrate has a minimal radius of curvature which is at least approximately 600 mm and may even reach 200 mm.

The inventors have demonstrated that, when the process for lamination of the cell 2 and of the first glass substrate 10 by the interlayer film made of polymeric material 30 or 31 is implemented using a liquid crystal cell, the encapsulation substrates 27 and 28 of which are made of thin glass (and not plastic material), this minimizes the risk of deformation when increasing the thickness of the cell, preventing damage to the electrodes and an inhomogeneous light transmission appearance once the glazing has finished being entirely assembled.

If the first interlayer 30 is a polymeric film, making it possible to secure the liquid crystal cell 2 to the first substrate by lamination, the second interlayer 40 is made of a transparent adhesive material in order to avoid having to subject the other face 21 of the liquid crystal cell, which has to be secured to the second glass substrate 11, to the steps of the lamination process. The second interlayer is a liquid OCA which is able to be crosslinked once deposited by a liquid route and coated with the second substrate. The OCA cures by polymerization means such as ultraviolet radiation. The OCA is for example an acrylic resin.

Furthermore, the laminated glazing 1 containing liquid crystals of the invention is preferably designed to protect the liquid crystal cell 2 from ultraviolet radiation, by virtue of one or more ultraviolet filters. The protection will be provided at least on one of the main faces of the cell, which face will correspond to that facing the exterior environment when the laminated glazing 1 is used in an opening which opens out to the outside. Preferably, the protection against ultraviolet radiation will be provided complementarily on the other main face of the cell 2 and/or at the edge face of the cell 2.

In the examples of FIGS. 1 and 2, at least the lamination interlayers 30 and 31 are films made of polymeric material which filters ultraviolet rays, not only below 400 nm but also at 400 nm. The ultraviolet blocking property is provided for example by particles embedded in the film which are able to block ultraviolet rays and which do not scatter in the visible radiation range. Advantageously, an ultraviolet film has a light transmission at least between 280 nm and 400 nm, in particular a light transmission at 400 nm, which is less than 1%, preferably less than 0.1%, more preferably still less than 0.01%.

Moreover, in order to ensure protection of the liquid crystal cell 2 against ultraviolet rays at its edge face, the frame 5 also constitutes an ultraviolet filter. The frame 5 also has a light transmission at least between 280 nm and 400 nm, in particular a light transmission at 400 nm, which is less than 1%, preferably less than 0.1%, more preferably still less than 0.01%.

The process for manufacturing the laminated glazing 1 of FIG. 1 is now described with regard to FIG. 5:
The first step (Step 1) consists in positioning, on a support surface 7 such as a counter-glass, which is coated with a non-stick coating 70, for example made of PTFE, the liquid crystal cell 2 and optionally arranging the frame 5 around the liquid crystal cell, then the first interlayer 30 made of polymeric material, such as a PVB film, optionally other elements to be laminated (such as the PDLC system 6 and the additional interlayer film 31 of the example of FIG. 3), and finally the first glass substrate 10, so as to form a stack. With the stack having been placed in a vacuum bag, it then undergoes the lamination operation to form a laminated assembly 1′.
The second step (Step 2) consists in removing the counter-glass 7 from the laminated assembly which is composed of the first glass substrate 10, the first interlayer 30, the liquid crystal cell 2 and optionally the frame 5.
The third step (Step 3) consists in arranging the liquid OCA between the second glass substrate 11 and the laminated assembly 1′ on the side of the liquid crystal cell 2, then in crosslinking the liquid OCA to obtain the second interlayer 40 and the laminated glazing 1.

The way in which the liquid OCA cures depends on its nature, with some OCAs crosslinking in particular by polymerization means such as ultraviolet radiation or some other energy supply, for example by heating, and others crosslinking at ambient temperature with the addition of a curing agent.

The support surface 7 may be an inflatable membrane.

When a frame 5 is necessary, the frame 5 is for example made of PVB and arranged all around the liquid crystal cell 2. As a variant, the frame 5 can be obtained by depositing a leak-tight barrier such as an adhesive on and at the edge of the counter-glass, and by depositing a liquid OCA between the cell and the barrier, then by curing the OCA. As yet another variant, the frame 5 may already be secured to the liquid crystal cell 2 when it is supplied.

In a first nonlimiting example of step 3, this step consists in depositing liquid OCA on the second glass substrate 11, then in depositing the laminated assembly 1′ thereon, on the side of the liquid crystal cell 2, and finally in crosslinking the OCA in order thus to form the second interlayer 40 and to obtain the laminated glazing 1 according to the invention.

In a second nonlimiting example of step 3, the second glass substrate 11 is kept spaced apart from the laminated assembly 1′ in order to form a cavity intended to be filled with the liquid OCA, the liquid crystal cell 2 facing said second glass substrate 11. The spacing and the leak-tightness are obtained by a peripheral seal comprising spacers, the height of which corresponds to the height of liquid OCA to be injected. One or more openings are made in the seal in order to introduce the liquid OCA by injection through said openings until it fills the whole cavity between the second glass substrate 11 and the liquid crystal cell 2. In order to accelerate the filling process, it is possible to provide vacuum suction through an opening opposite the injection opening(s). The OCA is then cured to obtain the laminated glazing 1 of the invention.

1. A laminated glazing with liquid crystal variable transmission, comprising a first glass substrate and a second glass substrate, at least one liquid crystal cell, a first interlayer placed between the first glass substrate and the liquid crystal cell, and a second interlayer placed between the second glass substrate and the liquid crystal cell, wherein said first interlayer is a film made of a polymeric material and in that said second interlayer is made of a transparent adhesive material (OCA) that is in the form of a liquid prior to the manufacture of the glazing and is crosslinkable.

2. The laminated glazing according to claim 1, wherein said first interlayer is based on at least one polymer selected from the following polymers: polyvinyl butyral (PVB), ethylene-vinyl acetate (EVA), polyurethane (PU), polyethylene terephthalate (PET), polyethylene, polycarbonate, polymethyl methacrylate, polyacrylate, polyvinyl chloride, polyacetate resin, acrylate, fluorinated ethylene propylene, polyvinyl fluoride, ethylene tetrafluoroethylene, and cyclic olefin copolymer (COC).

3. The laminated glazing according to claim 1, wherein said first interlayer constitutes an ultraviolet filter.

4. The laminated glazing according to claim 1, wherein it comprises a superposition of one or more other interlayer films made of polymeric material, placed between the first glass substrate and the liquid crystal cell, each of the interlayers constituting a film which may be provided with technical functionalities.

5. The laminated glazing according to claim 1, wherein it comprises a frame made of polymeric material which is arranged all around the liquid crystal cell and in contact with said first interlayer said frame preferably constituting an ultraviolet filter.

6. The laminated glazing according to claim 1, wherein said second interlayer made of an OCA is selected from the following materials: acrylic, polyvinyl acetate, polyurethane, silicone and epoxy.

7. The laminated glazing according to claim 1, wherein it comprises two liquid crystal cells, at least one of them being a cell comprising a liquid volume of liquid crystals mixed with dichroic dyes, the other liquid crystal cell being a liquid crystal system wherein the volume of liquid crystals is not in liquid form.

8. The laminated glazing according to claim 1, wherein it comprises at least one functional infrared protection layer, the functional layer being arranged inside the laminated glazing.

9. The laminated glazing according to claim 1, wherein the liquid crystal cell comprises substrates for the encapsulation of the liquid crystal volume, said encapsulation substrates being polymeric or glass-based.

10. A process for the manufacture of a laminated glazing according to claim 1, comprising:
positioning, on a support surface coated with a non-stick coating, the liquid crystal cell, and, optionally, arranging a frame surrounding the liquid crystal cell, then positioning the first interlayer made of polymeric material, optionally other elements to be laminated, and finally the first glass substrate;
carrying out the lamination operation in order to form a laminated assembly;
removing the support surface from the laminated assembly;
arranging the liquid OCA between the second glass substrate and the laminated assembly on the side of the liquid crystal cell;
crosslinking the liquid OCA to obtain the laminated glazing.

11. The manufacturing process according to claim 10, wherein the arranging the liquid OCA and crosslinking consist in depositing liquid OCA on the second glass substrate then in depositing the laminated assembly thereon, on the side of the liquid crystal cell, and finally in crosslinking the OCA in order to form the second interlayer.

12. The manufacturing process according to claim 10, wherein the arranging the liquid OCA and crosslinking consist in keeping the second glass substrate spaced apart from the laminated assembly in order to form a cavity intended to be filled with the liquid OCA, the liquid crystal cell facing said second glass substrate, the spacing and the leak-tightness being obtained by a peripheral seal comprising spacers, in making one or more openings in the seal in order to introduce the liquid OCA by injection through said openings until it fills the whole cavity between the second glass substrate and the liquid crystal cell, and finally in crosslinking the OCA in order thus to form the second interlayer.
